(19) United States
(12) Patent Application Publication
(10) Pub. No.: US 2024/0269662 A1
(43) Pub. Date: Aug. 15, 2024

(54) A STRUCTURED CATALYST

(71) Applicant: Topsoe A/S, Kgs. Lyngby (DK)

(72) Inventors: Peter Mølgaard MORTENSEN, Roskilde (DK); Sebastian Thor WISMANN, Charlottenlund (DK); Anders Helbo HANSEN

(73) Assignee: Topsoe A/S, Kgs. Lyngby (DK)

(21) Appl. No.: 18/565,902

(22) PCT Filed: Jun. 27, 2022
(86) PCT No.: PCT/EP2022/067534

§ 371 Date: Nov. 30, 2023

(30) Foreign Application Priority Data
Jun. 28, 2023 (EP) 21182136.8

(51) Int. Cl. B01J 35/56; B01J 19/24; B01J 19/32; B01J 35/33

(52) U.S. Cl. CPC B01J 35/56; B01J 19/2485; B01J 19/32; B01J 35/33; B01J 2219/00135; B01J 2219/2416; B01J 2219/2432; B01J 2219/2438; B01J 2219/32425; B01J 2219/32466

(57) ABSTRACT

A structured catalyst for catalyzing an endothermic reaction of a feed gas to convert it to a product gas is provided.

### TECHNICAL FIELD

A structured catalyst, a reactor system and a process for carrying out an endothermic reaction of a feed gas are provided, where heat for the endothermic reaction is provided by resistance heating.

### BACKGROUND

Synthesis gas production typically takes place in large chemical plants, due to the energy intensive reactions needed to facilitate the production. This makes small scale production difficult. The toxicity of the synthesis gas (especially due to the content of carbon monoxide), additionally, makes storage of the synthesis gas difficult and imposes a significant risk.

There is the need for on-demand synthesis gas production in smaller plants.

### SUMMARY

In a first aspect, a structured catalyst for catalyzing an endothermic reaction of a feed gas to convert it to a product gas is provided, said structured catalyst comprising at least one ceramic element and a first electrically conducting heating element, the ceramic element extending in a longitudinal direction from a first end to a second end, where said first end forms an inlet to said structured catalyst for said feed gas and said second end forms an outlet for said product gas, wherein at least a part of the ceramic element supports a catalytically active material, wherein the first electrically conducting heating element is fixed to the ceramic element, and wherein one of the ceramic element and the first electrically conducting heating element is arranged at least partly circumferentially around the other one of the ceramic element and the first electrically conducting heating element.

Thus, the first aspect provides a structured catalyst for catalyzing an endothermic reaction of a feed gas to convert it to a product gas, said structured catalyst comprising at least one ceramic element and a first electrically conducting heating element, the ceramic element extending in a longitudinal direction from a first end to a second end, where said first end forms an inlet to said structured catalyst for said feed gas and said second end forms an outlet for said product gas, wherein at least a part of the ceramic element supports a catalytically active material, wherein the first electrically conducting heating element is fixed to the ceramic element, and wherein the ceramic element is arranged at least partly circumferentially around the first electrically conducting heating element.

And the first aspect provides a structured catalyst for catalyzing an endothermic reaction of a feed gas to convert it to a product gas, said structured catalyst comprising at least one ceramic element and a first electrically conducting heating element, the ceramic element extending in a longitudinal direction from a first end to a second end, where said first end forms an inlet to said structured catalyst for said feed gas and said second end forms an outlet for said product gas, wherein at least a part of the ceramic element supports a catalytically active material, wherein the first electrically conducting heating element is fixed to the ceramic element, and wherein the first electrically conducting heating element is arranged at least partly circumferentially around the ceramic element.

In a second aspect, a reactor system for carrying out an endothermic reaction of a feed gas is provided, said reactor system comprising:
a) a structured catalyst according to the first aspect;
b) a pressure shell housing said structured catalyst, said pressure shell comprising an inlet for letting in said feed gas and an outlet for letting out product gas, wherein said inlet is positioned so that said feed gas enters said structured catalyst in a first end and said product gas exits said catalyst from a second end; and
c) a heat insulation layer between said structured catalyst and said pressure shell.

The term ‘an endothermic reaction of a feed gas’ should be understood as a reaction scheme wherein conversion of the feed gas to the product gas requires supply of energy from its surroundings to proceed.

In a further aspect, use of the structured catalyst according to the first aspect or the reactor according to the second aspect is provided, wherein the endothermic reaction(s) is(are) selected from the group consisting of steam methane reforming, hydrogen cyanide formation, methanol cracking, ammonia cracking, reverse water gas shift and dehydrogenation.

Additional aspects of the present technology are set out in the following detailed description, the figures, and the appended claims.

### LEGENDS TO THE FIGURES

FIG. 1A illustrates a cross section through an embodiment of the inventive reactor system with a structured catalyst, in a cross section.

FIG. 1B illustrates a cross section through an alternative embodiment of the inventive reactor system with a structured catalyst, in a cross section.

FIGS. 2A and 2B illustrate embodiments of a structured catalyst.

FIGS. 3A and 3B illustrate embodiments of a structured catalyst.

FIGS. 4A and 4B illustrate parts of embodiments of a structured catalyst.

FIGS. 5A-5F illustrate cross-sections through different embodiments of a structured catalyst.

FIGS. 6A and 6B schematically illustrate embodiments of a structured catalyst.

FIG. 7 schematically illustrates different embodiments of a structured catalyst.

FIG. 8A illustrates an enlarged view of a ceramic element of an embodiment of a structured catalyst.

FIG. 8B illustrates an enlarged view of a detail of an embodiment of a structured catalyst.

FIGS. 9A and 9B illustrate different view of two different embodiments of a structured catalyst.

FIG. 10 schematically illustrates an embodiment of a structured catalyst.

FIG. 11 illustrates parts of an embodiment of a structured catalyst.

### DETAILED DISCLOSURE

The present technology describes a structured catalyst for use in an electrically heated reactor to facilitate the task carrying out an endothermic reaction of a feed gas in a compact design in an on-demand approach.

Electrically heated reactors offer the possibility of making very compact chemical reactors as the heat for the reaction is delivered directly to the catalyst zone.

A compact electric reactor using a structured catalyst can easily be operated and use easy start-up principles to produce gas when needed. This gives a relatively inexpensive plant where gas can be produced in only the required amounts and little to no gas storage is needed, while transport of gas also is reduced or completely eliminated. Simple reactor equipment and simple operation of the process makes gas production attractive in delocalized plants which reduce risks of gas handling.

A structured catalyst for catalysing an endothermic reaction of a feed gas to convert it to a product gas is thus provided, said structured catalyst comprising at least one ceramic element and a first electrically conducting heating element, the ceramic element extending in a longitudinal direction from a first end to a second end, where said first end forms an inlet to said structured catalyst for said feed gas and said second end forms an outlet for said product gas, wherein at least a part of the ceramic element supports a catalytically active material, wherein the first electrically conducting heating element is fixed to the ceramic element, and wherein one of the ceramic element and the first electrically conducting heating element is arranged at least partly circumferentially around the other one of the ceramic element and the first electrically conducting heating element.

The at least one ceramic element extends in a longitudinal direction from a first end to a second end of the structured catalyst, where the first end forms an inlet to the structured catalyst for a feed gas and where the second end forms an outlet of the structured catalyst for the product gas.

The ceramic element may be an element formed substantially of a ceramic material.

The structured catalyst further comprises a first electrically conducting heating element, which first electrically conducting heating element is fixed to the ceramic element. The first electrically conducting heating element may comprises metallic material being an alloy comprising one or more substances selected from the group consisting of Fe, Cr, Al, Co, Ni, Zr, Cu, Ti, Mn, Si, Y, and C. The first electrically conducting heating element is configured for heating via resistance heating.

In the context of the present disclosure, the ceramic element is a self-contained element, i.e., not a coating. Additionally, the ceramic element is not randomly packed pellets. The ceramic element may be a self-supporting element, which may additionally provide a support for the electrically conducting heating element being fixed hereto. In the context of the present disclosure, the term ‘fixed’ should be understood as the electrically conducting heating element being attached to the ceramic element in a non-adhesive manner, e.g. by mechanical/physical forces or by engagement.

The structured catalyst may be configured to direct an electrical current to run through the electrically conducting heating element from the first end to the second end of the structured catalyst.

At least a part of the ceramic element supports a catalytically active material. The catalytically active material may constitute in the ranges of 0.1 to 30% catalytically active metal. In one embodiment, the catalytically active material may comprise catalytically active particles having a size in the range from about 5 nm to about 250 nm.

The disclosure provides a structured catalyst, where either the ceramic element or the first electrically conducting heating element is arranged at least partly circumferentially around the other one of the ceramic element and the first electrically conducting heating element. In other words, one of the ceramic element and the first electrically conducting heating element is arranged at least partly circumferentially around the other one of the ceramic element and the first electrically conducting heating element. Thus, the ceramic element may be arranged at least partly circumferentially around the first electrically conducting heating element. Alternatively, the first electrically conducting heating element may be arranged at least partly around the ceramic element.

The ceramic element may form an elongated shape and may comprises a cavity arranged along the longitudinal direction, whereby the ceramic element may form a hollow structure. At least a part of the first electrically conducting heating element may be arranged in the cavity to provide a ceramic element being arranged at least partly circumferentially around the first electrically element.

In an alternative embodiment, the ceramic element forms an elongated structure where the first electrically conducting heating element is arranged circumferentially around the elongated structure, e.g. by winding the first electrically conducting heating element around the elongated ceramic element. It should be understood, that the ceramic element may form an elongated hollow structure even if the first element is arranged at least partly circumferentially around the ceramic element.

The close proximity between the catalytically active material and the first electrically conducting heating element enables efficient heating of the catalytically active material by solid material heat conduction from the resistance heated first electrically conducting heating element. An important feature of the resistance heating process is thus that the energy is supplied inside the object itself, instead of being supplied from an external heat source via heat conduction, convection and/or radiation. Moreover, the hottest part of the reactor system comprising the structured catalyst will be within the pressure shell of the reactor system. Preferably, the electrical power supply and the structured catalyst are dimensioned so that at least part of the structured catalyst reaches a temperature of 850° C., preferably 900° C., more preferably 1000° C., more preferably 1100° C., or even more preferably 1300° ° C. The amount and composition of the catalytically active material can be tailored to the endothermic reaction at the given operating conditions.

The electrically conductive material for the first electrically conducting heating element is advantageously a coherent or consistently intra-connected material in order to achieve electrical conductivity throughout the electrically conductive material, and thereby achieve thermal conductivity throughout the structured catalyst and in particular providing heating of the catalyst material. By the coherent or consistently intra-connected material it is possible to ensure uniform distribution of current within the electrically conductive material and thus uniform distribution of heat within the structured catalyst. Throughout this text, the term “coherent” is meant to be synonymous to cohesive and thus refer to a material that is consistently intra-connected or consistently coupled. The effect of the structured catalyst being a coherent or consistently intra-connected material is that a control over the connectivity within the material of the structured catalyst and thus the conductivity of the electrically conductive material is obtained. It is to be noted that even if further modifications of the electrically conductive material are carried out, such as provision of cut-out spaces within parts of the electrically conductive material, the electrically conductive material is still denoted a coherent or consistently intra-connected material.

At least a part of the ceramic element may be porous thereby allowing for supporting the catalytically active material on and inside the ceramic element.

The ceramic element may in formed in one piece. In an alternative embodiment, the ceramic element may comprise a plurality of ceramic parts arranged in a row to thereby form the ceramic element. The ceramic parts may comprise matching engagement structures whereby two neighbouring ceramic parts may be attached to each other by these engagement structures. The matching engagement structures may as an example be formed by a protrusion at one end of the ceramic part and a matching indentation at an opposite other end, thereby a protrusion of one ceramic part may engage an indentation of a neighbouring ceramic part.

In an alternative embodiment, the ceramic parts may not be attached to each other. In this embodiment, the ceramic parts forming the ceramic element may be kept together in a row by the first electrically conducting heating element being fixed to the ceramic element, e.g. by use of ceramic parts being hollow and arranging the ceramic parts in a row on the first electrically conducting heating element, whereby the first electrically conducting heating element is arranged in the cavity formed by hollow ceramic part arranged in a row.

As an example, the ceramic parts may be cylindrical parts forming a ceramic element having a height in the range of 100-5000 mm in the longitudinal direction, preferably 500-3000 mm, the cylindrical parts being arranged circumferentially around said first electrically conducting element from a first end to a second end. In an embodiment said cylindrical ceramic parts may be stacked on top of each other as individual segments (parts) having a height in the longitudinal direction of approximately 10-500 mm.

The first electrically conducting heating element may at least partly support a porous ceramic coating. The term “support a ceramic coating” is meant to denote that the first electrically conducting heating element is coated by the ceramic coating at, at least, a part of the surface of the element. Thus, the term does not imply that all the surface of the first electrically conducting heating element is coated by the ceramic coating; in particular, at least the parts of the first electrically conducting heating element which are configured to be electrically connected to conductors do not have a coating thereon. The coating may be a ceramic material with pores in the structure which allows for supporting catalytically active material on and inside the coating. The ceramic coating is an electrically insulating material and will typically have a thickness in the range of around 100 μm, such as in the range of 10-500 μm.

In one embodiment, at least a part of the ceramic coating may support a catalytically active material. Advantageously, the catalytically active material comprises catalytically active particles having a size in the range from about 5 nm to about 250 nm. By additionally adding a catalytically active material on at least a part of the first electrically conducting heating element, the total amount of catalytically active material of the structured catalyst may be increased.

The structured catalyst may further comprise a second electrically conducting heating element extending in the longitudinal direction from the first end to the second end, where the second electrically conducting heating element is connected to the first electrically conducting heating element at the second end. The second electrically conducting heating element may comprises metallic material being an alloy comprising one or more substances selected from the group consisting of Fe, Cr, Al, Co, Ni, Zr, Cu, Ti, Mn, Si, Y, and C, and may be configured for heating via resistance heating.

The second electrically conducting heating element may at least partly support a porous ceramic coating. The term “support a ceramic coating” is meant to denote that the second electrically conducting heating element is coated by the ceramic coating at, at least, a part of the surface of the element.

In one embodiment, at least a part of the ceramic coating of the second electrically conducting heating element may support a catalytically active material. Advantageously, the catalytically active material comprises catalytically active particles having a size in the range from about 5 nm to about 250 nm. By additionally adding a catalytically active material on at least a part of the second electrically conducting heating element, the total amount of catalytically active material of the structured catalyst may be increased further.

The structured catalyst may be configured to direct an electrical current to run through the first electrically conducting heating element from the first end to said second end, then through the second electrically conducting heating element from the second end to the first end by electrically connecting the first and second electrically conducting heating element at the second end.

In one embodiment, where the ceramic element may be arranged at least partly circumferentially around the first electrically conducting heating element, the second electrically conducting heating element may be arranged at least partly circumferentially around the ceramic element. It should, however, be understood that the ceramic element may be arranged at least partly circumferentially around both the first and the second electrically conducting heating elements.

In an alternative embodiment, where the first electrically conducting heating element may be arranged at least partly around the ceramic element, the second electrically conducting heating element may be arranged in a cavity of the ceramic element being hollow. It should, however, be understood that both the first and the second electrically conducting heating elements may be arranged at least partly circumferentially around the ceramic element.

Thus, the second electrically conducting heating element may be arranged along an outer surface of the ceramic element.

The first electrically conducting heating element may form an elongated tube being arranged circumferentially around the ceramic element. This should be understood, that the tube may be a tube with openings, i.e. at that the tube does not necessarily form a closed space.

As an example, the first electrically conducting heating element may comprise a wire forming a helical pattern around the ceramic element thereby forming an open tube. In an alternative embodiment, the first electrically conducting heating element may comprise a wire forming a helical pattern arranged inside a cavity in the ceramic element.

A winding density of the helical pattern may be uniform at least along a part of the longitudinal direction. The winding density of the helical pattern may alternatively be non-uniform at least along a part of the longitudinal direction. In one embodiment, the density may vary, e.g. by providing a uniform density at the upper part of the structured catalyst, and a non-uniform winding density at the lower part of the structured catalyst, where the upper part is the part of the catalyst being closer to the first end than to the second end.

In one embodiment, the structured catalyst may comprise a ceramic element where an outer surface of the ceramic element comprises a plurality of grooves. The grooves may be uniformly arranged along the outer surface. Alternatively, the grooves may be non-uniformly arranged.

The grooves may in a cross-section along the longitudinal direction have a serrated form. Alternative, the grooves may in a cross-section along the longitudinal direction be arch-shaped or may form another shaped. Arch-shaped grooves may be provided with different radii, e.g. dependent on the diameter of the first and/or second electrically conducting heating element, and/or the size of the ceramic element.

The grooves may form a helical pattern along the outer surface. In one embodiment, the first electrically conducting heating element may be arranged at least partly in the grooves forming a helical pattern. In an alternative embodiment, the second electrically conducting heating element may be arranged at least partly in the grooves forming a helical pattern. It should be understood, that the grooves may form two helical patterns along the outer surface. Both the first and second helical pattern may extend from the first end to the second end, where the first helical pattern may be displaced relative to the second helical pattern.

To facilitate a current flow through the structured catalyst, the structured catalyst may further comprise at least a first and a second conductor, wherein the first conductor is electrically connected to the first electrically conducting heating element and to an electrical power supply, wherein said electrical power supply is dimensioned to heat at least a part of said first electrically conducting heating element to a temperature of at least 500° C. by passing an electrical current through said electrically element(s), the first conductor being connected at a position on the first electrically conducting heating element closer to said first end than to said second end.

In one embodiment, the second conductor may be connected to the first electrically conducting heating element at a position on the first electrically conducting heating element closer to said second end than to said first end, where the structured catalyst is configured to direct an electrical current to run from the first conductor through the first electrically conducting heating element to said second end.

In an alternative embodiment, the second conductor may be connected to the second electrically conducting heating element at a position on the second electrically conducting heating element closer to said first end than to said second end, where the structured catalyst may be configured to direct an electrical current to run from the first conductor through the first electrically conducting heating element to said second end, then through the second electrically conducting heating element to the second conductor.

Preferably, the first and second conductors are connected to first end of the structured catalyst or within a quarter of the length of the electrically conducting heating element(s), the quarter being located closest to the first end, in embodiments comprising first and second electrically conducting heating elements.

To facilitate attachment of the first and second conductors, the first and/or second electrically conducting heating elements may each comprise an attachment section to allow attachment of first and second conductor, respectively.

A reactor system for carrying out an endothermic reaction of a feed gas is provided, said reactor system comprising:
a) a structured catalyst as described herein;
b) a pressure shell housing said structured catalyst, said pressure shell comprising an inlet for letting in said feed gas and an outlet for letting out product gas, wherein said inlet is positioned so that said feed gas enters said structured catalyst in a first end and said product gas exits said catalyst from a second end; and
c) a heat insulation layer between said structured catalyst and said pressure shell.

The structured catalyst as described above is very suitable for the reactor system for carrying out an endothermic reaction of a feed gas. The remarks set forth above in relation to the structured catalyst are therefore equally applicable in relation to the reactor system.

The reactor system may comprise at least two conductors electrically connected to the structured catalyst and to an electrical power supply placed outside said pressure shell, wherein said electrical power supply is dimensioned to heat at least part of said structured catalyst to a temperature of at least 500° C. by passing an electrical current through the first and second electrically conducting heating elements, wherein said at least two conductors are connected to the first electrically conducting heating element at a position closer to the first end, and wherein the structured catalyst is constructed to direct an electrical current to run from one conductor substantially via the first electrically conducting heating element to the second electrically conducting heating element and return to a second of said at least two conductors.

The term “electrically conductive” is meant to denote materials with an electrical resistivity in the range from: 10⁻⁵ to 10⁻⁸ Ω·m at 20° C. Thus, materials that are electrically conductive are e.g. metals like copper, silver, aluminum, chromium, iron, nickel, or alloys of metals.

Moreover, the term “electrically insulating” is meant to denote materials with an electrical resistivity above 10 Ω·m at 20° C., e.g. in the range from 109 to 1025 Ω·m at 20° C.

Preferably, the conductors are made of a different material than the electrically conducting heating elements. The conductors may for example be of iron, nickel, aluminium, copper, silver, or an alloy thereof.

The layout of the reactor system allows for feeding a pressurized feed gas to the reactor system at an inlet and directing this gas into the pressure shell of the reactor system. Inside the pressure shell, a configuration of heat insulation layers and inert material is arranged to direct the feed gas through the structured catalyst where it will be in contact with the ceramic element and the catalytically active material supported on the ceramic element, where the catalytically active material will facilitate the endothermic reaction. Additionally, the heating of the structured catalyst will supply the required heat for the endothermic reaction. The product gas from the structured catalyst is led to the reactor system outlet.

Typically, the pressure shell comprises an inlet for letting in feed gas and an outlet for letting out product gas, wherein the inlet is positioned close to a first end of the pressure shell and the outlet is positioned close to a second end of the pressure shell, and wherein the at least two conductors both are connected to the structured catalyst at a position on the structured catalyst closer to the inlet than to the outlet. Hereby, the at least two conductors can be placed in the substantially colder part of the reactor system as the inlet gas will have lower temperature than the product gas, the electrically conductive material will be colder in the most upstream part of the material due to the heat consumed by the progress of the heating, and the feed gas fed through the inlet may cool the at least two conductors before being heated by the heated structured catalyst further along the path of the gas over the heated structured catalyst. It is an advantage that the temperature of other electrically conducting parts except the first and second electrically conducting heating elements is kept down in order to protect the connections between the conductors and the structured catalyst. When the temperature of the conductors and other electrically conducting parts, except the first and second electrically conducting heating elements, is relatively low, less limitations on materials suitable for the conductors and other electrically conducting parts, except the first and second electrically conducting heating elements, exists. When the temperature of the first and second electrically conducting heating elements increase, the resistivity thereof increases; therefore, it is desirable to avoid unnecessary heating of all other parts than the electrically conducting heating elements within the heating system. The term “electrically conducting parts, except the electrically conducting heating elements” is meant to cover the relevant electrically conducting parts arranged to connect the power supply to the structured catalyst, except the electrically conducting structured catalyst itself.

It should be noted that the system of the invention may include any appropriate number of power supplies and any appropriate number of conductors connecting the power supply/supplies and the electrically conducting heating element(s) of the structured catalyst.

The at least two conductors may be led through a pressure shell in a fitting so that the at least two conductors are electrically insulated from the pressure shell. The fitting may be, partly, of a plastic and/or ceramic material. The term “fitting” is meant to denote a device that allows for mechanically connecting two pieces of hardware in a pressure bearing configuration. Thereby, the pressure within the pressure shell may be maintained even though the at least two conductors are lead through it. Non-limiting examples of the fittings may be an electrically insulating fitting, a dielectric fitting, a power compression seal, a compression fitting or a flange. The pressure shell typically comprises side walls, end walls, flanges and possibly further parts. The term “pressure shell” is meant to cover any of these components.

The connection between the structured catalyst and the at least two conductors may be a mechanical connection, a welded connection, a brazed connection, or a combination thereof. The structured catalyst may comprise terminals physically and electrically connected to the structured catalyst in order to facilitate the electrical connection between the first and second electrically conducting heating elements and the at least two conductors. The term “mechanical connection” is meant to denote a connection where two components are held together mechanically, such as by a threaded connection or by clamping, so that a current may run between the components.

The gas flow over the structured catalyst may be axial or co-axial with the current path through the structured catalyst, perpendicular to the current path or have any other appropriate direction in relation to the current path.

The electrical power supply may be dimensioned to heat at least part of said structured catalyst to a temperature of at least 700° C., preferably at least 900° C., more preferably at least 1000° C.

When the pressure shell comprises an inlet for letting in feed gas and an outlet for letting out product gas, where the inlet is positioned so that the feed gas enters the structured catalyst in a first end of the structured catalyst and the product gas exits the structured catalyst from a second end of the structured catalyst, and when the at least two conductors both are connected to the structured catalyst at a position on the structured catalyst closer to the inlet than to the outlet, the at least two conductors can be placed in the relatively colder part of the reactor system. The first end of the structured catalyst has a lower temperature than the second end of the structured catalyst due to:
the feed gas fed led through the inlet may cool the at least two conductors before being heated by the structured catalyst further along the path of the gas through the structured catalyst;
the feed gas inlet into the first end of the structured catalyst will have lower temperature than the product gas leaving the second end of the structured catalyst, due to the heat supplied to the structured catalyst electrically,
The endothermic nature of the reactions absorbs heat from its surroundings,
The structured catalyst is constructed to direct an electrical current to run from one conductor substantially to the second end of the structured catalyst and return to a second of the at least two conductors.

The temperature profile in the structured catalyst may correspond to a substantially continuously increasing temperature along the path of the feed gas through the structured catalyst.

When the reactor system of the invention is used to facilitate the steam reforming reaction it has several advantages over the more traditionally used fired tubular reformer. The reactor system of the invention does not need a furnace, and this reduces the overall reactor size considerably. Moreover, it is an advantage that the amount of product gas produced in a single pressure shell is increased considerably compared to known tubular steam reformers. In a standard tubular steam reformer, the amount of product gas produced in a single tube of the tubular steam reformer is up to 500 Nm³/h. In comparison, the reactor system of the invention is arranged to produce up to or more than 2000 Nm³/h, e.g. even up to or more than 10000 Nm³/h, within a single pressure shell. This can be done without the presence of O₂ in the feed gas and with less than 10% methane in the synthesis gas produced. When a single pressure shell houses catalyst for producing up to 10000 Nm³/h, or more, product gas, it is no longer necessary to provide a plurality of pressure shells or means for distributing feed gas to a plurality of such separate pressure shells.

Another advantage of the reactor system is that the flow through the structured catalyst within the reactor system may be up-flow. Alternatively, the flow through the structured catalyst could be in the horizontal direction or any other appropriate direction. This is more difficult in the case where the reactor contains pellets due to the risk of fluidization, grinding, and blowing out the pellets. Thereby, a substantial amount of piping may be avoided, thus reducing plant costs. Furthermore, the possibility of up-flow or horizontal flow increases the flexibility in plant design.

Moreover, it should be noted that the term “the at least two conductors are connected to the structured catalyst at a position on the structured catalyst closer to the first end of the structured catalyst than to the second end of the structured catalyst” is meant to denote that both/all of the at least two conductors are connected closer to the first end of the structured catalyst than to the second end. Preferably, the at least two conductors are connected to first end of the structured catalyst or within the quarter of the length of the/an electrically conducting heating element closest to the first end.

In an embodiment, the reactor system further comprises a bed of a catalyst material, such as catalyst pellets, upstream the structured catalyst within the pressure shell. Here, the term “upstream” is seen from the flow direction of the feed gas. Thus, the term “upstream” is here meant to denote that the feed gas is directed through the bed of catalyst material prior to reaching the structured catalyst. Such a bed of a catalyst may perform a preconditioning of the feed mixture, by e.g. an adiabatic reaction towards a thermal equilibrium of a chemical reaction such as water-gas-shift.

Additionally/alternatively, the bed of a catalyst material may be used as guard to prevent contamination of the downstream structured catalyst by impurities such as sulphur and/or chlorine. No specific heating needs to be provided to the bed of catalyst material; however, the bed of catalyst material may be heated indirectly if it is in close proximity to the structured catalyst.

In an embodiment a bed of catalyst material is placed within the pressure shell and downstream the structured catalyst. Such catalyst material may be in the form of catalyst pellets, extrudates or granulates. This provides for a situation where the catalyst material can be arranged for lowering the approach to equilibrium of the gas leaving the structured catalyst by making a pseudo adiabatic equilibration of the relevant reactions.

The pressure shell may have a design pressure of between 2 bar and 30 bar. The actual operating pressure will be determined by the size of the plants, among other aspects. As the hottest part of the heating system is the electrically conductive material, which will be surrounded by heat insulation layer and within the pressure shell of the heating system, the temperature of the pressure shell can be kept significantly lower than the maximum process temperature. This allows for having a relative low design temperature of the pressure shell of e.g. 700° ° C. or 500° C. or preferably 300° C. or 100° ° C. of the pressure shell whilst having maximum process temperatures of 400° C., or even 900, or even 1100° C., or even up to 1400° C. on the structured catalyst. Material strength is higher at the lower of these temperatures (corresponding to the design temperature of the pressure shell as indicated above). This offers advantages when designing the heating system. Thus, the pressure shell may have a design pressure of between 2 bar and 30 bar, or between 30 and 200 bar. Around 30 bar is preferable as a compromise between process economy and thermodynamic limitations.

The resistivity of the electrically conductive material may be between 10⁻⁵ Ω·m and 107 Ω·m. A material with a resistivity within this range provides for an efficient heating of the structured catalyst when energized with a power source. Graphite has a resistivity of about 10⁻⁵ Ω·m at 20° C., kanthal has a resistivity of about 10⁻⁶ Ω·m at 20° C., whilst stainless steel has a resistivity of about 10⁻⁷ Ω·m at 20° C. The electrically conductive material may for example be made of FeCrAlloy having a resistivity of ca. 1.5·10⁻⁶ Ω·m at 20° C.

The reactor system may further comprise a control system arranged to control the electrical power supply to ensure that the temperature of the product gas exiting the pressure shell lies in a predetermined range.

Typically, the height of the reactor system may be between 0.5 and 7 m, more preferably between 0.5 and 3 m.

Use of the structured catalyst described above or the reactor described above is provided, wherein the endothermic reaction is selected from the group consisting of steam methane reforming, hydrogen cyanide formation, methanol cracking, ammonia cracking, reverse water gas shift and dehydrogenation.

It should be understood, that a skilled person would readily recognise that any feature described in combination with the structured catalyst and the reactor system for carrying out an endothermic reaction of a feed gas is applicable for this use. The remarks set forth above in relation to the structured catalyst and the reactor system are therefore equally applicable in relation to the use hereof.

The term “dehydrogenation” is meant to denote the following reaction:

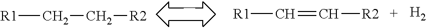

Where R1 and R2 may be any appropriate group in a hydrocarbon molecule, such as —H, —CH₃, —CH₂, or —CH.

In an embodiment, the endothermic reaction is dehydrogenation of hydrocarbons. The catalytically active material may be Pt. The maximum temperature of the reactor may be between 500-700° C. The pressure of the feed gas may be 2-5 bar.

The term “water gas shift” is meant to denote the following reactions:

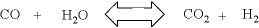

In an embodiment, the endothermic reaction is the reverse water gas shift reaction (the reverse reaction of water gas shift). The maximum temperature of the reactor may be between 600-1300° C. The pressure of the feed gas may be 2-80 bar, preferably 10-40 bar. In an embodiment said first electrically conducting heating element is made of an alloy of Fe Cr Al, which may additionally support a ceramic coating of a ZrO₂ and Al₂O₃ mixture, with Mn as catalytically active material. In another embodiment, said first electrically conducting heating element is made of an alloy of Fe Cr Al, which may additionally support a ceramic coating of a ZrO₂ and MgAl₂O₄ mixture, with Ni as catalytically active material.

The term “methanol cracking” is meant to denote the following reactions:

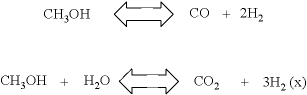

Typically, methanol cracking reaction is accompanied by the water gas shift reaction.

In an embodiment, the endothermic reaction is cracking of methanol. The maximum temperature of the reactor may be between 200-300° C. The pressure of the feed gas may be 2-30 bar, preferably about 25 bar. In an embodiment said first electrically conducting heating element is made of an alloy of Fe Cr Al, which may additionally support a ceramic coating of a ZrO₂ and Al₂O₃ mixture, with CuZn as catalytically active material. In another embodiment, said first electrically conducting heating element is made of an alloy of Fe Cr Al, which may additionally support a ceramic coating of a ZrO₂ and MgAl₂O₄ mixture, with Ni as catalytically active material.

Moreover, the term “steam reforming” is meant to denote a reforming reaction according to one or more of the following reactions:

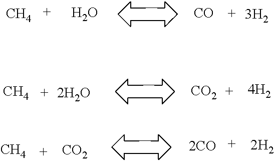

These reactions are typically coupled with the water gas shift reaction as well.

In an embodiment, the endothermic reaction is steam reforming of hydrocarbons. The maximum temperature of the reactor may be between 850-1300° C. The pressure of the feed gas may be 5-180 bar, preferably about 25 bar. The catalytically active material may be Ni, Ru, Rh, Ir, or a combination thereof, while the ceramic coating may be Al₂O₃, ZrO₂, MgAl₂O₄, CaAl₂O₄, or a combination therefore and potentially mixed with oxides such as Y, Ti, La, or Ce. In an embodiment said first electrically conducting heating element is made of an alloy of Fe Cr Al, which may support a ceramic coating of a ZrO₂ and MgAl₂O₄ mixture, with nickel as catalytically active material.

The term “ammonia cracking” is meant to denote the following reactions:

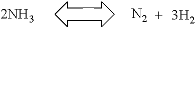

In an embodiment, the endothermic reaction is ammonia cracking. The catalytically active material may be Fe or Ru. The maximum temperature of the reactor may be between 400-700° C. The pressure of the feed gas may be 2-30 bar, preferably about 25 bar.

The term “hydrogen cyanide synthesis” is meant to denote the following reactions:

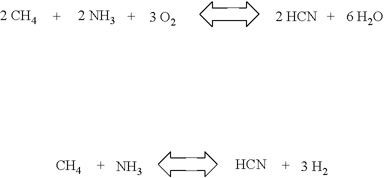

In an embodiment, the endothermic reaction is the hydrogen cyanide synthesis or a synthesis process for organic nitriles. The catalytically active material may be Pt, Co, or SnCo. The maximum temperature of the reactor may be between 700-1200° C. The pressure of the feed gas may be 2-30 bar, preferably about 5 bar.

### DETAILED DESCRIPTION OF THE FIGURES

Throughout the Figures, like reference numbers denote like elements.

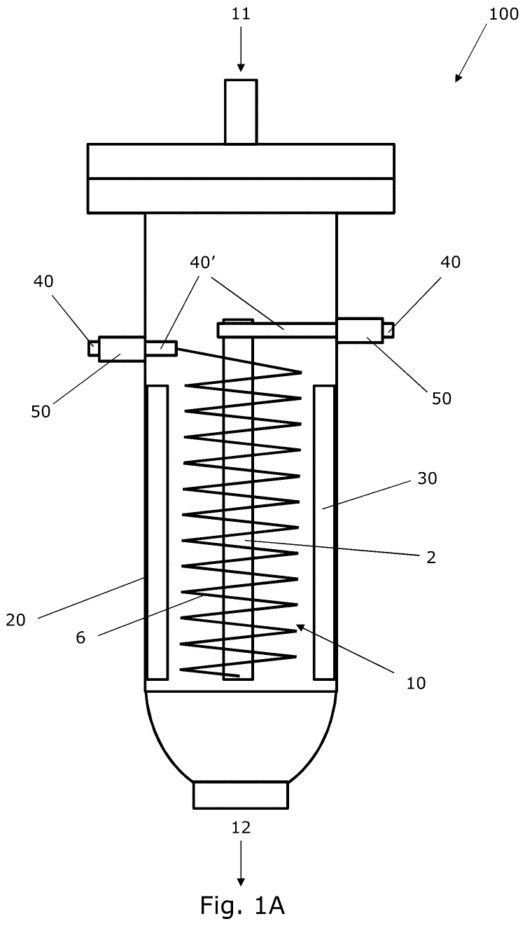

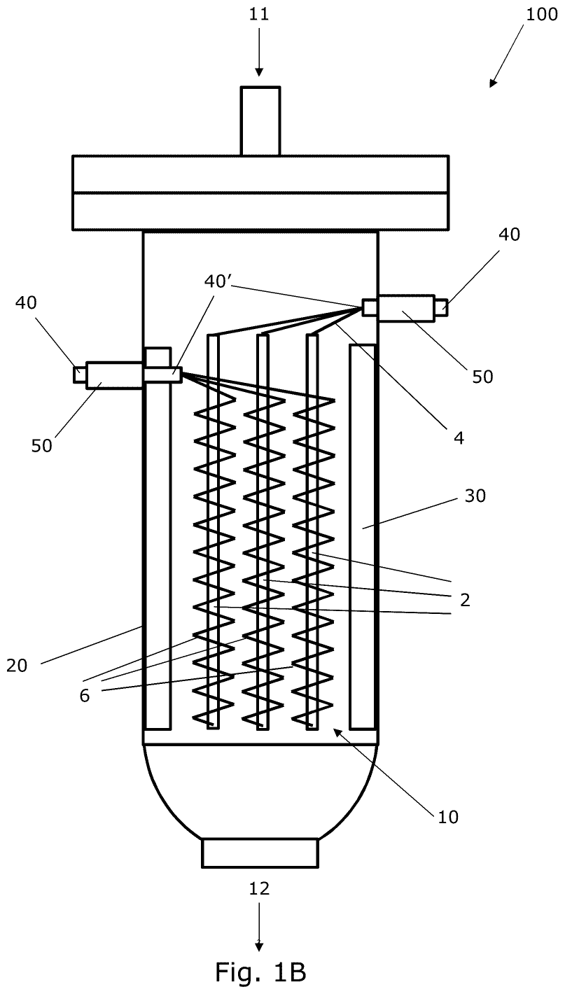

FIGS. 1A and 1B show a cross section through two different embodiments of a reactor system 100 according to the invention. The reactor system 100 comprises a structured catalyst 10. The structured catalyst 10 comprises a ceramic element 2, a first electrically conducting heating element 4 (see FIG. 1B), and a second electrically conducting heating element 6.

In the embodiment illustrated in FIG. 1B, the reactor system 100 comprises three structured catalysts 10 arranged in an array. Each structured catalyst 10 comprises a ceramic element 2, a first electrically conducting heating element 4, and a second electrically conducting heating element 6.

The ceramic element 2 extends in a longitudinal direction from a first end to a second end, where the first end forms an inlet 11 to the structured catalyst 10 for feed gas and where the second end forms an outlet 12 for product gas. At least a part of the ceramic element 2 supports a catalytically active material.

The reactor system 100 moreover comprises conductors 40, 40′ connected to a power supply (not shown in the Figures) and to the structured catalyst 10, viz. the array. The conductors 40, 40′ are led through the wall of a pressure shell 20 housing the structured catalyst and through insulating material 30 on the inner side of the pressure shell, via fittings 50. The conductors 40′ are connected to the array of macroscopic structures 5 by conductor contact rails (not shown).

In an embodiment, the electrical power supply supplies a voltage of 26V and a current of 1200 A. In another embodiment, the electrical power supply supplies a voltage of 5V and a current of 240 A. The current is led through electrical conductors 40, 40′ to conductor contact rails, and the current runs through the structured catalyst 10 from one conductor contact rail, e.g. from the conductor contact rail to the left in FIG. 1A, to the other conductor contact rail, e.g. the conductor contact rail to the right in FIG. 1A via the first electrically conducting heating element 4 and the second electrically conducting heating element 6. The current can be both alternating current, and e.g. run alternating in both directions, or direct current and run in any of the two directions.

In the illustrated embodiments, a major part of the first electrically conducting heating element 4 is arranged in a cavity in the ceramic element 2 being a hollow elongated element. The ceramic element 2 is thus arranged circumferentially around the first electrically conducting heating element 2, whereas the second electrically conducting heating element 6 is arranged circumferentially around the ceramic element 2. The first and second electrically conducting heating elements 4, 6 are connected to each other at the second end.

The structured catalyst 10 is configured to direct an electrical current to run through the first electrically conducting heating element 4 from the first end to said second end, then through the second electrically conducting heating element 6 from the second end to the first end by electrically connecting the first and second electrically conducting heating elements 4, 6 at the second end.

The first and second electrically conducting heating elements 4, 6 are made of electrically conductive material. Especially preferred is the alloy Kanthal consisting of aluminium, iron and chrome. The conductors 40, 40′ are made in materials like iron, aluminium, nickel, copper or alloys thereof.

In the array, illustrated in the reactor system 100 in FIG. 1B, the structured catalyst 10 is configured to direct an electrical current to run through each of the first electrically conducting heating element 4 from the first end to said second end, then through each of the second electrically conducting heating element 6 from the second end to the first end by electrically connecting one of the first electrically conducting heating elements 4 to one of the second electrically conducting heating elements 6 at the second end.

In the reactor system shown in FIGS. 1A and 1B, the conductors 40, 40′ are led through the wall of a pressure shell 20 housing the structured catalyst 10 and through insulating material 30 on the inner side of the pressure shell, via fittings 50. Feed gas for the endothermic reaction is inlet into the reactor system 100 via an inlet in the upper side of the reactor system 100 as shown by the arrow 11, and product gas exits the reactor system 100 via an outlet in the bottom of the reactor system 100 as shown by the arrow 12. Moreover, one or more additional inlets (not shown) advantageously exist close to or in combination with the fittings 50. Such additional inlets allow a cooling gas to flow over, around, close to, or inside at least one conductor within the pressure shell to reduce the heating of the fitting. The cooling gas could e.g. be hydrogen, nitrogen, methane or mixtures thereof. The temperature of the cooling gas at entry into the pressure shell may be e.g. about 100° C.

In the reactor system 100 shown in FIGS. 1A and 1B, inert material (not shown) is advantageously present between the lower side of the structured catalyst 10 and the bottom of the pressure shell. Moreover, inert material is advantageously present between the outer sides of the structured catalyst 10 and the insulating material 30. Thus, one side of the insulating material 30 faces the inner side of the pressure shell 20 and the other side of the insulating material 30 faces the inert material. The inert materiel is e.g. ceramic material and may be in the form of pellets. The inert material assists in controlling the pressure drop across the reactor system 100 and in controlling the flow of the gas through the reactor system 100, so that the gas flows over the surfaces of the structured catalyst 10.

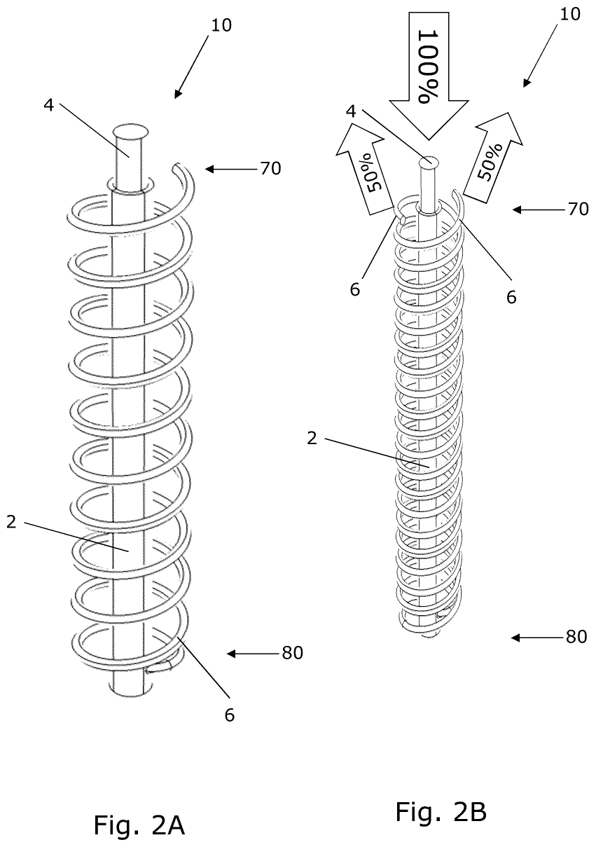

FIGS. 2A and 2B illustrate two different embodiments of a structured catalyst 10. The structured catalyst 10 comprises a ceramic element 2, a first electrically conducting heating element 4, and a second electrically conducting heating element 6.

The ceramic element 2 extends in a longitudinal direction from a first end 70 to a second end 80. At least a part of the ceramic element 2 supports a catalytically active material (not shown).

The ceramic element 2 is arranged circumferentially around the first electrically conducting heating element 2, where a major part of the first electrically conducting heating element 4 is arranged in a cavity in the ceramic element 2 being a hollow elongated element. The second electrically conducting heating element 6 is arranged circumferentially around the ceramic element 2. The first and second electrically conducting heating elements 4, 6 are connected to each other at the second end 80. The first electrically conductive element 4 comprises a rod, whereas the second electrically conducting heating element 6 in FIG. 2A comprises wire forming a helical pattern and in FIG. 2B comprises two wires forming two helical patterns.

The structured catalyst 10 is configured to direct an electrical current to run through the first electrically conducting heating element 4 from the first end 70 to the second end 80, then through the second electrically conducting heating element 6 from the second end 80 to the first end 70 by electrically connecting the first and second electrically conducting heating elements 4, 6 at the second end 80. The arrows illustrate, that 100% of the current is directed through the first electrically conducting heating element 4, whereas 50% of the current is directed through each of the second conducting heating elements 6.

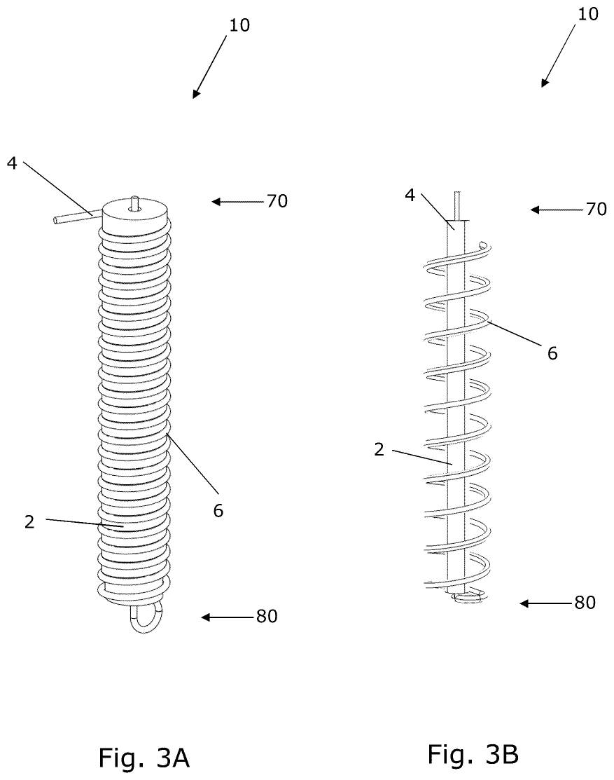

FIGS. 3A and 3B illustrate two different embodiments of a structured catalyst 10. The structured catalyst 10 comprises a ceramic element 2, a first electrically conducting heating element 4, and a second electrically conducting heating element 6.

The ceramic element 2 extends in a longitudinal direction from a first end 70 to a second end 80. At least a part of the ceramic element 2 supports a catalytically active material (not shown).

The ceramic element 2 is arranged circumferentially around the first electrically conducting heating element 2, and the second electrically conducting heating element 6 is arranged circumferentially around the ceramic element 2. The first and second electrically conducting heating elements 4, 6 are connected to each other at the second end 80. The first and second electrically conductive elements 4, 6 both comprises a wire, where the second electrically conducting heating element 6 forms a helical pattern. The winding density of the helical pattern of the second electrically conducting heating element 6 is narrower in FIG. 3A compared to FIG. 3B.

The structured catalyst 10 is configured to direct an electrical current to run through the first electrically conducting heating element 4 from the first end 70 to the second end 80, then through the second electrically conducting heating element 6 from the second end 80 to the first end 70 by electrically connecting the first and second electrically conducting heating elements 4, 6 at the second end 80.

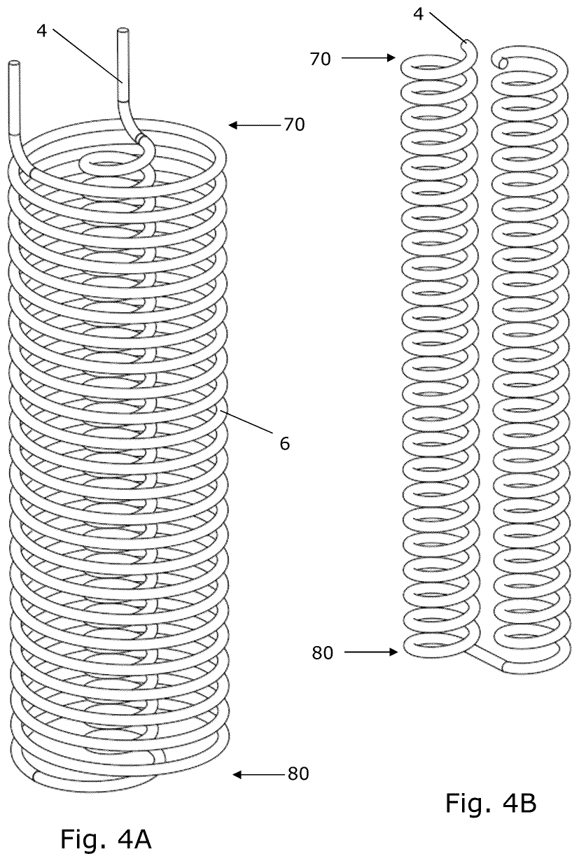

FIGS. 4A and 4B illustrate parts of embodiments of a structured catalyst 10.

FIG. 4A illustrates a first electrically conducting heating element 4 and a second electrically conducting heating element 6 being connected to each other at the second end 80. Both the first and the second electrically conducting heating elements 4, 6 forms a helical pattern, where the winding density is substantially identical. However, the diameter of the helical pattern of the first electrically conducting heating element 4 is smaller than the diameter of the helical pattern of the second electrically conducting heating element 6. This coil-in-coil element 4, 6 is configured to be fixed to a substantially tube-shaped ceramic element 2 by arranging the first electrically conducting heating element 4 in a cavity of the ceramic element, whereby the second electrically conducting heating element 6 is arranged circumferentially around the ceramic element along the outer surface hereof.

An electrical current may be directed through the first electrically conducting heating element 4 from the first end 70 to the second end 80, then through the second electrically conducting heating element 6 from the second end 80 to the first end 70.

FIG. 4B illustrates a first electrically conducting heating element 4 forming two helical patterns, where the winding density is substantially identical, and where the diameter of the helical patterns is substantially identical. The first electrically conducting heating element 4 is configured to be fixed to two substantially rod-shaped ceramic elements 2 by arranging a ceramic element 2 inside each of the helical pattern formed by the first electrically conducting heating element 4.

An electrical current may be directed through the first electrically conducting heating element 4 from the first end 70 to the second end 80, then through the next part of the first electrically conducting heating element 4 from the second end 80 to the first end 70.

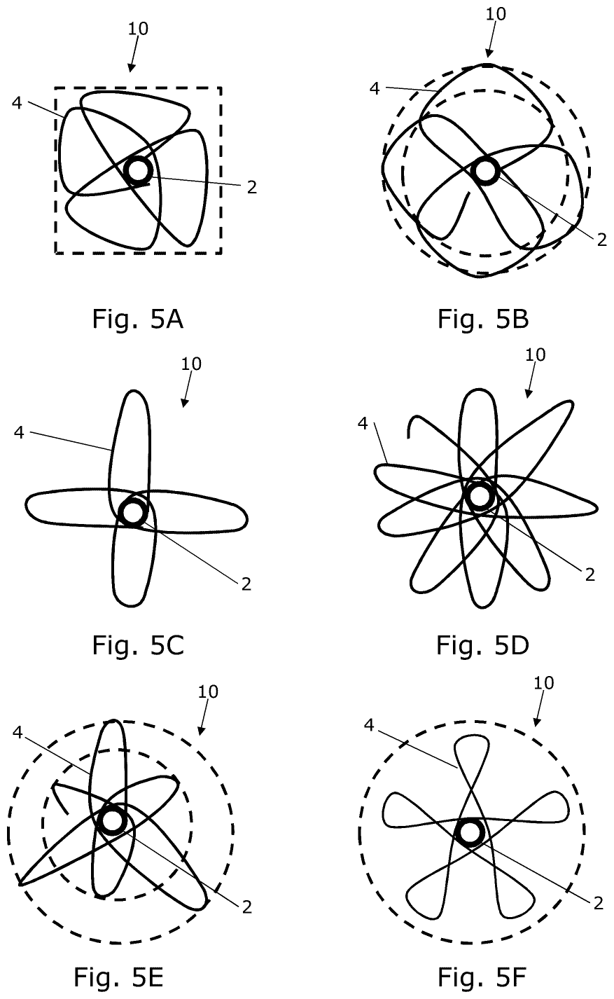

FIGS. 5A-5F illustrate cross-sections through different embodiments of a structured catalyst 10. The structured catalyst 10 comprises a ceramic element 2 and a first electrically conducting heating element 4.

The ceramic element 2 extends in a longitudinal direction from a first end 70 to a second end 80. At least a part of the ceramic element 2 supports a catalytically active material (not shown). The cross-section is transverse to the longitudinal direction.

The first electrically conducting heating element 4 is arranged circumferentially around the ceramic element 2 which is a hollow elongated element. A second electrically conducting heating element 6 can be arranged inside the hollow ceramic element 2 and can be electrically connected to the first electrically conducting heating element 4 at the second end 80.

The first electrically conductive element 4 comprises in each of the illustrated embodiment a wire forming a helical pattern around the outer surface of the ceramic element 2.

The structured catalyst 10 is configured to direct an electrical current to run through the first electrically conducting heating element 4 from the first end 70 to the second end 80. If a second electrically conductive element 6 is connected to the first electrically conductive element 4, the current may subsequently be directed through the second electrically conducting heating element 6 from the second end 80 to the first end 70.

The dotted lines illustrate the outer boundary of the first electrically conducting heating element 4.

In FIG. 5A, the outer boundary is substantially in the shape of a square. The helical pattern is irregular along the longitudinal direction.

In FIG. 5B, two circular dotted lines illustrate that the helical pattern formed by the first electrically conducting heating element 4 has different diameters along the longitudinal direction.

In FIG. 5C, the first electrically conducting heating element 4 forms a helical pattern forming four narrow petals in a cross-section.

The embodiment illustrated in FIG. 5D is similar to the embodiment of FIG. 5C, with the exception that the first electrically conducting heating element 4 forms a helical pattern forming eight narrow petals in a cross-section.

In FIG. 5E, the two circular dotted lines illustrate that the helical pattern formed by the first electrically conducting heating element 4 has different diameters along the longitudinal direction.

In FIG. 5F a further alternative cross-sectional shape of the first electrically conducting heating element 4 is illustrated.

It should be understood, that the different cross-sectional shapes of the first electrically conducting heating element 4 are non-limiting, as other shapes may also be applicable.

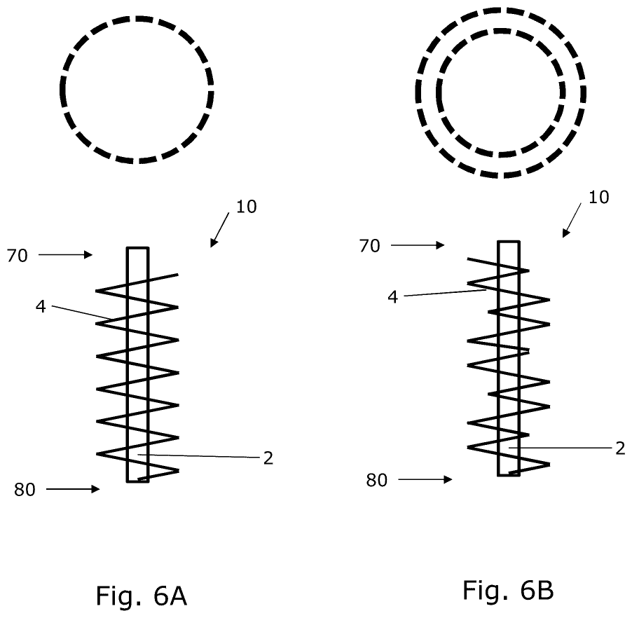

FIGS. 6A and 6B schematically illustrate two different embodiments of a structured catalyst 10 in the lower part of the figures. The structured catalyst 10 comprises a ceramic element 2 and a first electrically conducting heating element 4.

The ceramic element 2 extends in a longitudinal direction from a first end 70 to a second end 80. At least a part of the ceramic element 2 supports a catalytically active material (not shown). The first electrically conducting heating element 4 is arranged circumferentially around the ceramic element 2.

The first electrically conductive element 4 comprises in both of the illustrated embodiments a wire forming a helical pattern around the outer surface of the ceramic element 2.

In FIG. 6A, the winding density of the first electrically conducting heating element 2 is uniform and with a constant diameter. In FIG. 6B, diameter of the helical pattern formed by the first electrically conducting heating element 2 is non-uniform. The dotted lines in the upper part of the figures, illustrate the outer boundary of the first electrically conducting heating element 4.

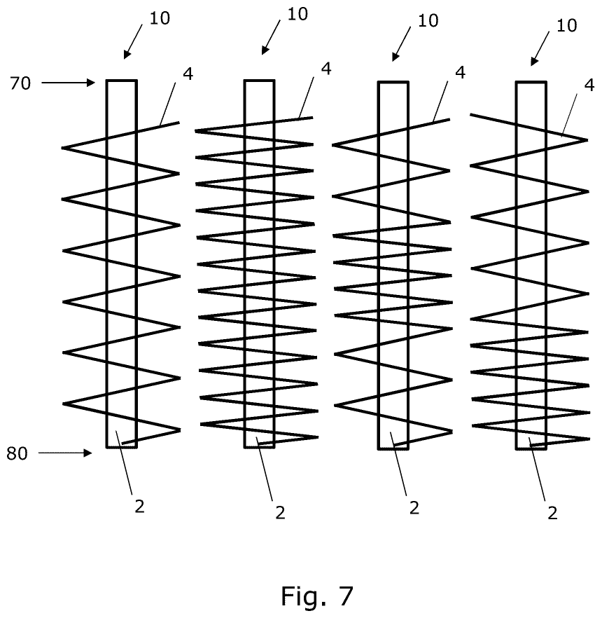

FIG. 7 schematically illustrates four different embodiments of a structured catalyst 10. The structured catalyst 10 comprises a ceramic element 2 and a first electrically conducting heating element 4.

The ceramic element 2 extends in a longitudinal direction from a first end 70 to a second end 80. At least a part of the ceramic element 2 supports a catalytically active material (not shown). The first electrically conducting heating element 4 is arranged circumferentially around the ceramic element 2.

In the two first embodiments, the winding density of the first electrically conducting heating element 2 is uniform, where the first winding density is wide, and the second winding density is narrow.

In the third and the fourth embodiments, the winding density of the first electrically conducting heating element 2 is non-uniform. In the third embodiment, winding density at the upper part and the lower part is wide, whereas the winding density at the middle part is narrow. In the fourth embodiment, winding density at the upper part is wind, whereas the winding density at the lower part is narrow.

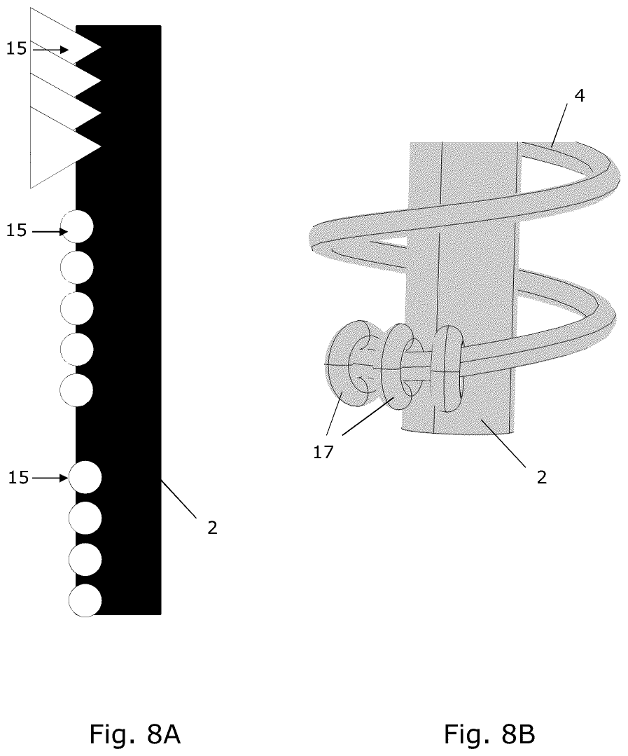

FIG. 8A illustrates an enlarged view of a part of a ceramic element 2 of an embodiment of a structured catalyst 10.

The outer surface of the ceramic element comprises a plurality of grooves 15 which may be uniformly or non-uniformly arranged along the outer surface. As illustrated, the grooves may in a cross-section along the longitudinal direction have a serrated form (upper part of the ceramic element 2). Alternative, the grooves may in a cross-section along the longitudinal direction be arch-shaped. The arch-shaped grooves may be provided with different radii, as illustrate in the middle section and the lower part of the ceramic element 2.

The grooves 15 may form a helical pattern along the outer surface. The first electrically conducting heating element 4 may be arranged in the grooves 15.

FIG. 8B illustrates an enlarged view of a detail of an embodiment of a structured catalyst 10. The structured catalyst 10 comprises a ceramic element 2 and a first electrically conducting heating element 4.

The ceramic element 2 extends in a longitudinal direction from a first end 70 to a second end 80. At least a part of the ceramic element 2 supports a catalytically active material (not shown). The first electrically conducting heating element 4 is arranged circumferentially around the ceramic element 2.

Additionally, a plurality of ceramic elements 17 are arranged on the wire-shaped first electrically conducting heating element 4. In the illustrated embodiment, the ceramic element are holed pellets which may support at catalytically active material to thereby form catalyst pellets 17.

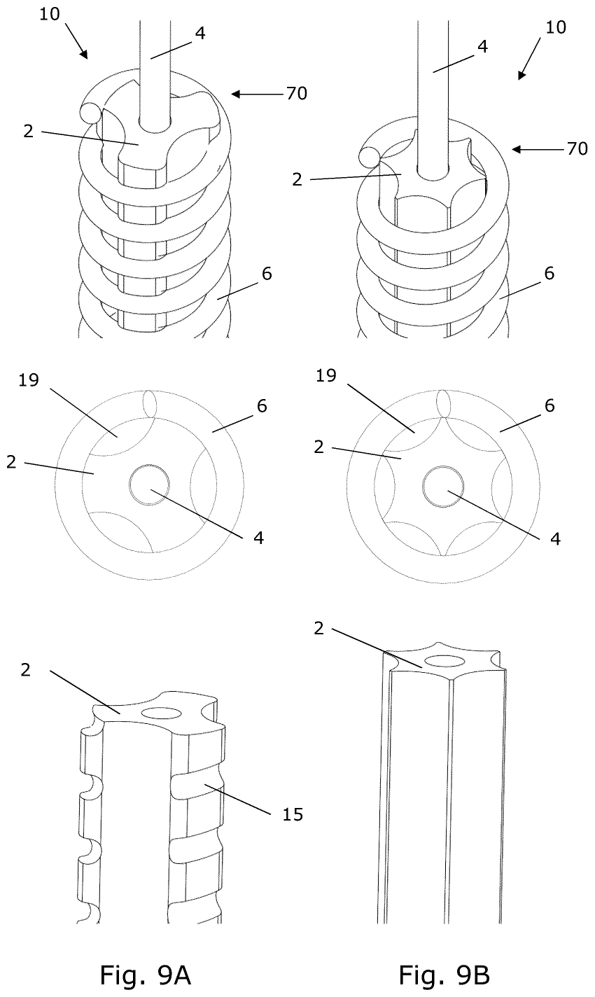

FIGS. 9A and 9B illustrate different view of two different embodiments of a structured catalyst 10. In both embodiments, the structured catalyst 10 comprises a ceramic element 2, a first electrically conducting heating element 4, and a second electrically conducting heating element 6.

The ceramic element 2 extends in a longitudinal direction from a first end 70 to a second end 80 (not shown). At least a part of the ceramic element 2 supports a catalytically active material (not shown).

The ceramic element 2 is arranged circumferentially around the first electrically conducting heating element 2, and the second electrically conducting heating element 6 is arranged circumferentially around the ceramic element 2. The first and second electrically conducting heating elements 4, 6 are connected to each other at the second end 80 (not shown). The first and second electrically conductive elements 4, 6 both comprises a wire, where the second electrically conducting heating element 6 forms a helical pattern.

The structured catalyst 10 is configured to direct an electrical current to run through the first electrically conducting heating element 4 from the first end 70 to the second end 80, then through the second electrically conducting heating element 6 from the second end 80 to the first end 70 by electrically connecting the first and second electrically conducting heating elements 4, 6 at the second end 80.

The middle part of the figures illustrates a cross-section transverse to the longitudinal direction for each of the two embodiments. The openings 19 between the ceramic element 2 and the first electrically conducting heating element 4 ensure that a larger area of the electrically conducting heating element 2 is exposed to the flow of gas while at the same time being fixed to the ceramic element 2.

The lower part of the figures illustrates the ceramic element 2. In the embodiment illustrated in FIG. 9A, the ceramic element 2 comprises a plurality of grooves 15 transverse to the longitudinal direction. The grooves 15 form a helical pattern in which the first electrically conductive element 2 is arranged (see the upper part of FIG. 9A).

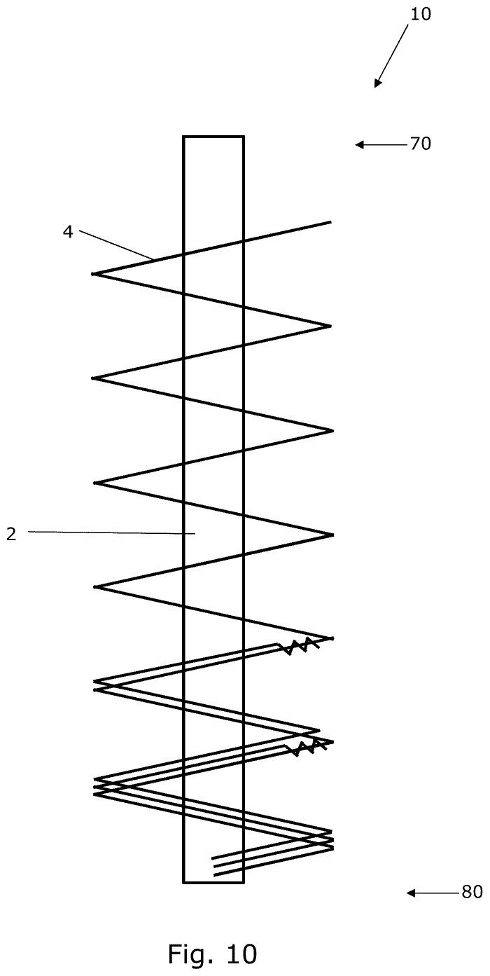

FIG. 10 schematically illustrates an embodiment of a structured catalyst 10. The structured catalyst 10 comprises a ceramic element 2 and a first electrically conducting heating element 4.

The ceramic element 2 extends in a longitudinal direction from a first end 70 to a second end 80. At least a part of the ceramic element 2 supports a catalytically active material (not shown). The first electrically conducting heating element 4 comprises a wire and is arranged circumferentially around the ceramic element 2 in a helical pattern. The winding density of the first electrically conducting heating element 2 is uniform along the length of the ceramic element 2. At the lower part of the structured catalyst 10, the first electrically conducting heating element 4 comprises an additional wire to thereby decrease the current density where the temperature of the structured catalyst 10 is highest. This may reduce the risk of overheating of the structured catalyst 10 and in particular reduce the risk of overheating of the first electrically conducting heating element 4.

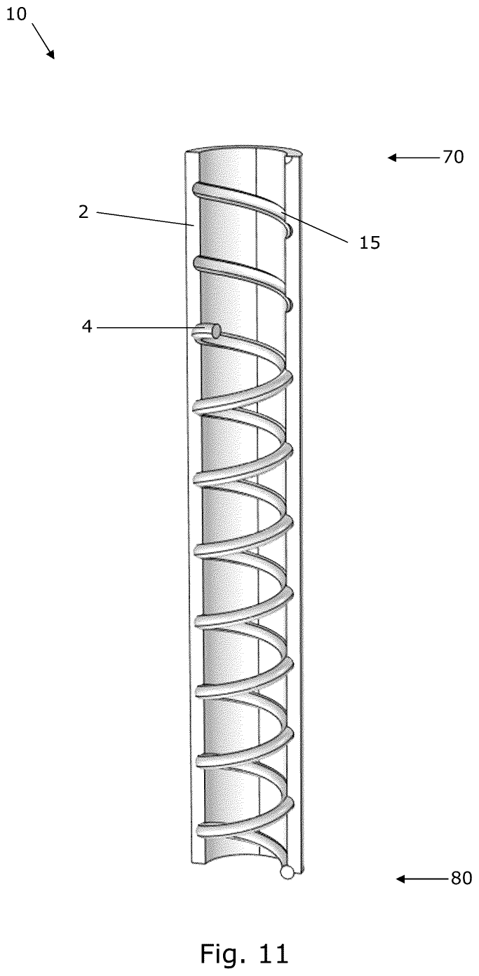

FIG. 11 illustrates parts of an embodiment of a structured catalyst 10. The structured catalyst 10 comprises a ceramic element 2 and a first electrically conducting heating element 4.

The ceramic element 2 extends in a longitudinal direction from a first end 70 to a second end 80. At least a part of the ceramic element 2 supports a catalytically active material (not shown). The ceramic element 2 is a hollow element and is arranged circumferentially around the first electrically conducting heating element 4 which forms a helical pattern. On an inner surface of the hollow ceramic element 2, a groove 15 is provided in a helical pattern whereby the groove 15 stabilises the first electrically conducting heating element 4.

The following numbered items are provided:

Item 1. A structured catalyst for catalysing an endothermic reaction of a feed gas to convert it to a product gas, said structured catalyst comprising at least one ceramic element and a first electrically conducting heating element, the ceramic element extending in a longitudinal direction from a first end to a second end, where said first end forms an inlet to said structured catalyst for said feed gas and said second end forms an outlet for said product gas, wherein at least a part of the ceramic element supports a catalytically active material, wherein the first electrically conducting heating element is fixed to the ceramic element, and wherein one of the ceramic element and the first electrically conducting heating element is arranged at least partly circumferentially around the other one of the ceramic element and the first electrically conducting heating element.

Item 2. A structured catalyst according to item 1, wherein at least a part of the ceramic element is porous.

Item 3. A structured catalyst according to item 1 or 2, wherein the ceramic element comprises a plurality of ceramic parts arranged in a row to form the ceramic element.

Item 4. A structured catalyst according to any of the preceding items, wherein the first electrically conducting heating element at least partly supports a porous ceramic coating.

Item 5. A structured catalyst according to any of the preceding items, further comprising a second electrically conducting heating element extending in the longitudinal direction from the first end to the second end, wherein the second electrically conducting heating element is connected to the first electrically conducting heating element at the second end.

Item 6. A structured catalyst according to any of the preceding items, wherein the ceramic element forms an elongated shape and comprises a cavity arranged along the longitudinal direction, and wherein at least a part of the first electrically conducting heating element is arranged in the cavity.

Item 7. A structured catalyst according to items 5 and 6, wherein the second electrically conducting heating element is arranged along an outer surface of the ceramic element.

Item 8. A structured catalyst according to any of items 1-5, wherein the first electrically conducting heating element forms an elongated tube being arranged circumferentially around the ceramic element.

Item 9. A structured catalyst according to item 8, wherein the first electrically conducting heating element comprises a wire forming a helical pattern around the ceramic element.

Item 10. A structured catalyst according to item 9, wherein a winding density of the helical pattern is uniform at least along a part of the longitudinal direction.

Item 11. A structured catalyst according to item 9 or 10, wherein a winding density of the helical pattern is non-uniform at least along a part of the longitudinal direction.

Item 12. A structured catalyst according to any of the preceding items, wherein an outer surface of the ceramic element comprises a plurality of grooves.

Item 13. A structured catalyst according to item 12, wherein the grooves form a helical pattern along the outer surface.

Item 14. A structured catalyst according to item 13, wherein the first electrically conducting heating element is arranged at least partly in the grooves.

Item 15. A structured catalyst according to any of the preceding items, further comprising at least a first and a second conductor, wherein the first conductor is electrically connected to the first electrically conducting heating element and to an electrical power supply, wherein said electrical power supply is dimensioned to heat at least part of said first electrically conducting heating element to a temperature of at least 500° C. by passing an electrical current through said electrically conducting heating element, the first conductor being connected at a position on the first electrically conducting heating element closer to said first end than to said second end.

Item 16. A structured catalyst according to item 15, wherein the second conductor is connected to the first electrically conducting heating element a position on the first electrically conducting heating element closer to said second end than to said first end, the structured catalyst being configured to direct an electrical current to run from the first conductor through the first electrically conducting heating element to said second end.

Item 17. A structured catalyst according to items 5 and 15, wherein the second conductor is connected to the second electrically conducting heating element a position on the second electrically conducting heating element closer to said first end than to said second end, the structured catalyst being configured to direct an electrical current to run from the first conductor through the first electrically conducting heating element to said second end, then through the second electrically conducting heating element to the second conductor.

Item 18. A structured catalyst according to any of the preceding items, wherein the first electrically conducting heating element comprises a metallic material being an alloy comprising one or more substances selected from the group consisting of Fe, Cr, Al, Co, Ni, Zr, Cu, Ti, Mn, Si, Y, and C.

Item 19. A reactor system for carrying out an endothermic reaction of a feed gas, said reactor system comprising:
a) a structured catalyst according to any of the preceding items;
b) a pressure shell housing said structured catalyst, said pressure shell comprising an inlet for letting in said feed gas and an outlet for letting out product gas, wherein said inlet is positioned so that said feed gas enters said structured catalyst in a first end and said product gas exits said catalyst from a second end; and
c) a heat insulation layer between said structured catalyst and said pressure shell.

Item 20. A reactor system according to item 19, wherein said electrical power supply is dimensioned to heat at least part of said structured catalyst to a temperature of at least 700° ° C., preferably at least 900° C., more preferably at least 1000° C.

Item 21. A reactor system according to any of items 19-20, wherein the pressure shell has a design pressure of between 2 and 30 bar.

Item 22. A reactor system according to any of items 19-20, wherein the pressure shell has a design pressure of between 30 and 200 bar.

Item 23. A reactor system according to any of items 19-22, wherein the resistivity of the material of the electrically conducting heating element is between 10⁻⁵ Ω·m and 10⁻⁷ Ω·m.

Item 24. A reactor system according to any items 19-23, where said at least two conductors are led through the pressure shell in a fitting so that the at least two conductors are electrically insulated from the pressure shell.

Item 25. A reactor system according to any of items 19-24, wherein the connection between the structured catalyst and said at least two conductors is a mechanical connection, a welded connection, a brazed connection, or a combination thereof.

Item 26. A reactor system according to any of items 19-25, further comprising a control system arranged to control the electrical power supply to ensure that the temperature of the product gas exiting the pressure shell lies in a predetermined range.

Item 27. A reactor system according to any of items 19-26, wherein the height of the reactor system is between 0.5 and 7 m, more preferably between 0.5 and 3 m.

Item 28. Use of the structured catalyst according to any of items 1-18 or the reactor according to any of items 19-27, wherein the endothermic reaction is selected from the group consisting of steam methane reforming, hydrogen cyanide formation, methanol cracking, ammonia cracking, reverse water gas shift, and dehydrogenation.

1. A structured catalyst for catalysing an endothermic reaction of a feed gas to convert it to a product gas, said structured catalyst comprising at least one ceramic element and a first electrically conducting heating element, the ceramic element extending in a longitudinal direction from a first end to a second end, where said first end forms an inlet to said structured catalyst for said feed gas and said second end forms an outlet for said product gas, wherein at least a part of the ceramic element supports a catalytically active material, wherein the first electrically conducting heating element is fixed to the ceramic element, and wherein one of the ceramic element and the first electrically conducting heating element is arranged at least partly circumferentially around the other one of the ceramic element and the first electrically conducting heating element.

2. A structured catalyst according to claim 1, wherein at least a part of the ceramic element is porous.

3. A structured catalyst according to claim 1, wherein the ceramic element comprises a plurality of ceramic parts arranged in a row to form the ceramic element.

4. A structured catalyst according to claim 1, wherein the first electrically conducting heating element at least partly supports a porous ceramic coating.

5. A structured catalyst according to claim 1, further comprising a second electrically conducting heating element extending in the longitudinal direction from the first end to the second end, wherein the second electrically conducting heating element is connected to the first electrically conducting heating element at the second end.

6. A structured catalyst according to claim 1, wherein the ceramic element forms an elongated shape and comprises a cavity arranged along the longitudinal direction, and wherein at least a part of the first electrically conducting heating element is arranged in the cavity.

7. A structured catalyst according to claim 5, wherein the ceramic element forms an elongated shape and comprises a cavity arranged along the longitudinal direction, and wherein at least a part of the first electrically conducting heating element is arranged in the cavity, wherein the second electrically conducting heating element is arranged along an outer surface of the ceramic element.

8. A structured catalyst according to claim 1, wherein the first electrically conducting heating element forms an elongated tube being arranged circumferentially around the ceramic element.

9. A structured catalyst according to claim 8, wherein the first electrically conducting heating element comprises a wire forming a helical pattern around the ceramic element.

10. A structured catalyst according to claim 1, wherein an outer surface of the ceramic element comprises a plurality of grooves.

11. A structured catalyst according to claim 10, wherein the first electrically conducting heating element is arranged at least partly in the grooves.

12. A structured catalyst according to claim 1, further comprising at least a first and a second conductor, wherein the first conductor is electrically connected to the first electrically conducting heating element and to an electrical power supply, wherein said electrical power supply is dimensioned to heat at least part of said first electrically conducting heating element to a temperature of at least 500° C. by passing an electrical current through said electrically conducting heating element, the first conductor being connected at a position on the first electrically conducting heating element closer to said first end than to said second end.

13. A structured catalyst according to claim 12, wherein the second conductor is connected to the first electrically conducting heating element a position on the first electrically conducting heating element closer to said second end than to said first end, the structured catalyst being configured to direct an electrical current to run from the first conductor through the first electrically conducting heating element to said second end.

14. A structured catalyst according to claim 13, further comprising a second electrically conducting heating element extending in the longitudinal direction from the first end to the second end, wherein the second electrically conducting heating element is connected to the first electrically conducting heating element at the second end, wherein the second conductor is connected to the second electrically conducting heating element a position on the second electrically conducting heating element closer to said first end than to said second end, the structured catalyst being configured to direct an electrical current to run from the first conductor through the first electrically conducting heating element to said second end, then through the second electrically conducting heating element to the second conductor.

15. A structured catalyst according to claim 1, wherein the first electrically conducting heating element comprises a metallic material being an alloy comprising one or more substances selected from the group consisting of Fe, Cr, Al, Co, Ni, Zr, Cu, Ti, Mn, Si, Y, and C.

16. A reactor system for carrying out an endothermic reaction of a feed gas, said reactor system comprising:
a) a structured catalyst according to claim 1;
b) a pressure shell housing said structured catalyst, said pressure shell comprising an inlet for letting in said feed gas and an outlet for letting out product gas, wherein said inlet is positioned so that said feed gas enters said structured catalyst in a first end and said product gas exits said catalyst from a second end; and
c) a heat insulation layer between said structured catalyst and said pressure shell.

17. A method of using the reactor according to claim 16, wherein the endothermic reaction is selected from the group consisting of steam methane reforming, hydrogen cyanide formation, methanol cracking, ammonia cracking, reverse water gas shift, and dehydrogenation.
